(19) United States
(12) Patent Application Publication
(10) Pub. No.: US 2025/0313429 A1
(43) Pub. Date: Oct. 9, 2025

(54) SYSTEMS AND METHODS FOR DISPLAY DEVICES FOR ELEVATOR SYSTEMS

(71) Applicant: TK Elevator Innovation and Operations GmbH, Duesseldorf (DE)

(72) Inventor: Chih-Hung Aaron King, Sharpsburg, GA (US)

(73) Assignee: TK Elevator Innovation and Operations GmbH, Duesseldorf (DE)

(21) Appl. No.: 19/095,659

(22) Filed: Mar. 31, 2025

Related U.S. Application Data
(60) Provisional application No. 63/574,978, filed on Apr. 5, 2024.

(51) Int. Cl. B66B 3/00; B66B 1/34

(52) U.S. Cl. CPC B66B 3/002; B66B 1/3407

(57) ABSTRACT

Embodiments of the present disclosure are directed to a display device that includes one or more processors. The one or more processors are configured to receive a service mode code value as a request to display a graphical element display information, search a data storage repository for an identifier that is associated with at least one of a plurality of pre-stored graphical element display information data, the identifier is associated with the service mode code value, determine whether there is a match between the identifier for at least one of the plurality of pre-stored graphical element display information data and the service mode code value for the graphical element display information to be displayed, and upon determination of the match, display the one of the plurality of pre-stored graphical element display information data associated with the service mode code value by the display device.

### CROSS-REFERENCE TO RELATED APPLICATIONS

The present application claims the priority of benefit from U.S. Provisional Patent Application Ser. No. 63/574,978 filed Apr. 5, 2024, and entitled “Systems and Methods to Improve In-Elevator Cab Operating Panel Display Devices”, the entire contents of which is incorporated herein in its entirety.

### TECHNICAL FIELD

The present disclosure generally relates to elevator systems, and more particularly, to systems and methods to improve in-elevator cab display devices.

### BACKGROUND

Currently, displaying a new elevator mode in elevator cab operating panel involves software changes to a display to allow recognizing a new mode packet from an elevator controller that internally contains a graphic element to display. As such, the change requires software development of the application software of a cab operating panel (COP) device displays (position indicator, touchscreen, and the like). For example, when there is a request for the COP display to display a graphic banner indicating that the elevator cab is in a special service mode, current methods would involve controller software change as well as a device software change to the COP display device. As such, a need exists for improved systems and methods to eliminate the requirement for software changes to the COP display device.

### SUMMARY

In one embodiment, a display device of an elevator system that includes one or more processors is provided. The one or more processors are configured to receive a service mode code value as a request to display a graphical element display information, the service mode code value transmitted from an elevator controller, search a data storage repository for an identifier that is associated with at least one of a plurality of pre-stored graphical element display information data, the identifier is associated with the service mode code value; determine whether there is a match between the identifier for at least one of the plurality of pre-stored graphical element display information data and the service mode code value for the graphical element display information to be displayed, and upon determination of the match, display the one of the plurality of pre-stored graphical element display information data associated with the service mode code value by the display device.

In another embodiment, a method for displaying data on a display device is provided. The method includes creating at least one graphical element display information data using a first computing processing unit, associating each of the at least one graphical element display information data with an identifier, transmitting the at least one graphical element display information data with the corresponding identifier to the display device, and receiving, by the display device, a service mode code value as a request to display a graphical element display information. The method continues in response, the display device searching a data storage repository for the identifier that is associated with at least one of a plurality of pre-stored graphical element display information data based on the service mode code value, determining whether there is a match between the identifier of one of the plurality of pre-stored graphical element display information data and the service mode code value, and upon determination of the match, displaying the at least one of the plurality of pre-stored graphical element display information data associated with the service mode code value by the display device.

In another embodiment, an elevator system is provided. The elevator system includes a computing processing unit and an elevator assembly. The computing processing unit is configured to generate and transmit a plurality of pre-stored graphical element display information data. Each one of the plurality of pre-stored graphical element display information data has an identifier. The elevator assembly includes an elevator cab, an elevator controller, and a display device. The elevator controller is configured to control operation of the elevator cab and to transmit a service mode code value indicative of a current operating condition of the elevator system. The transmitted service mode code value is a request to display a graphical element display information. The display device includes one or more processors configured to receive the plurality of pre-stored graphical element display information data, receive the service mode code value indicative of the request to display the graphical element display information, in response to receiving the service mode code value, search a data storage repository for the identifier that is associated with at least one of the plurality of pre-stored graphical element display information data based on the service mode code value, determine whether there is a match between the identifier for at least one of the plurality of pre-stored graphical element display information data and the service mode code value, and upon determination of the match, display the at least one of the plurality of pre-stored graphical element display information data associated with the service mode code value by the display device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1A schematically depicts a first aspect of an example elevator system schematic, according to one or more embodiments shown and described herein;

FIG. 1B schematically depicts a second aspect of an example elevator system schematic, according to one or more embodiments shown and described herein;

FIG. 2 depicts an in-elevator cab operating panel display device of the example elevator system of FIGS. 1A-1B, according to one or more embodiments shown and described herein;

FIG. 3 schematically depicts a first illustrative computing network for an example in-cab display system of the example elevator system of FIGS. 1A-1B, according to one or more embodiments shown and described herein;

FIG. 4A schematically depicts illustrative hardware and software components of the in-elevator cab operating panel display device of FIG. 2 that may be used for displaying an in-cab customized graphical element information without a need for further software or application programming, according to one or more embodiments described and illustrated herein;

FIG. 4B schematically depicts an illustrative memory device containing illustrative logic components, according to one or more embodiments shown and described herein;

FIG. 4C schematically depicts an illustrative data storage repository containing illustrative data components, according to one or more embodiments shown and described herein;

FIG. 5 depicts a flow chart of a first example method for creating and transmitting a customized graphical element information data to the in-elevator COP display device according to one or more embodiments shown and described herein;

FIG. 6 depicts a flow chart of an example method for assigning a customized graphical element information data to an elevator operating condition without the need for further software or application programming according to one or more embodiments shown and described herein;

FIG. 7 depicts a flow chart of an example method for displaying a customized graphical element information data on the in-elevator COP display device without the need for further software or application programming, according to one or more embodiments shown and described herein;

FIG. 8 schematically depicts a second illustrative computing network for an example in-hall display system of the example elevator system of FIGS. 1A-1B, according to one or more embodiments shown and described herein;

FIG. 9 schematically depicts a partial environmental view of an example lobby of a current floor of a building that includes an in-hall display device of the in-hall display system of FIG. 8 according to one or more embodiments shown and described herein; and

FIG. 10 depicts a flow chart of an example method for displaying a customized graphical element information on the in-hall display device without the need for further software or application programming, according to one or more embodiments shown and described herein.

### DETAILED DESCRIPTION

Embodiments of the present disclosure are directed to improved systems and methods for permitting a change of a display on a display device (e.g., an in-elevator cab-operating panel (COP), an in-hall device, and the like) without a need for a software change in the display device. In embodiments, a user may utilize a web-based design tool to design or create a customized graphical element information such as numbers, words, images, objects, combinations thereof, and the like. The web-based design tool may transmit data to a design-computing module of an elevator system. The design-computing module may be communicatively coupled to an elevator controller and to the display device that is desired for the customized graphical element information to be displayed to the passengers/people when the elevator cab or the elevator system is in the specific elevator service mode.

The customized graphical element display information may be assigned or associated with a service mode code value such that when a specific service mode code value is generated by the elevator controller, there is a desire by the elevator controller to display the graphical element display information. As such, in the embodiments described herein, instead of transmitting the customized graphical element display information itself, which may have a very large data footprint and require large bandwidth, when the customized graphical element display information is desired to be displayed, the elevator controller may simply transmit a request (e.g., a numerical code value, a service mode code value, and the like, which may be embedded within a communication packet). Upon receiving the communication packet, one or more processors of the display device are configured to search a data storage repository for a plurality of pre-stored graphical element display information data that may include theme configurations, to determine whether there is a match between at least one of the plurality of pre-stored graphical element display information data and the desired customized graphical element display information based on a match between an identifier for each of the plurality of pre-stored graphical element display information data and the service mode code value. When there is a determination that there is a match, the display device retrieves the at least one pre-stored plurality of pre-stored graphical element display information data that matches the service mode code value and displays the and displays the at least one pre-stored plurality of pre-stored graphical element display information data, which is the desired customized graphical element display information.

Accordingly, the embodiments described herein improve computer functionality by permitting limited data to be transmitted between the elevator controller, the design-computing module, and the display device, thereby reducing the amount of memory required, reduction in a data storage required, and a reduction in an amount of transmitted data that is required to be stored on the elevator controller and/or the design-computing module, and transmitted between the elevator controller, the design-computing module, and/or the display device. Further, the embodiments described herein improve computer graphic user interfaces by permitting customized graphical element display information to be displayed of the display device without the requirement of additional software changes to the display device.

As such, the embodiments described herein are an improvement over conventional systems by providing a scalable systems and methods to support new or modified elevator service modes and does not need software development effort to create new application software for supporting any new elevator service modes that is outside of the current standard modes. Further, the embodiments described herein provide an improvement over conventional systems by reducing labor costs associated to installation since no software update is required. Lastly, the embodiments described herein provide an improvement over conventional systems by the ability to include unlimited customized graphical element display information associated with unlimited new and/or modified elevator service modes, which improve the quality of the customized graphical element display information since custom software is not required.

Various embodiments for permitting a change of a display on display device without a need for a software change in the display device and the operation thereof will be described in more detail herein.

The phrase “communicatively coupled” is used herein to describe the interconnectivity of various components of the monitoring system for elevator assemblies and means that the components are connected either through wires, optical fibers, or wirelessly such that electrical, optical, data, and/or electromagnetic signals may be exchanged between the components. It should be understood that other means of connecting the various components of the system not specifically described herein are included without departing from the scope of the present disclosure.

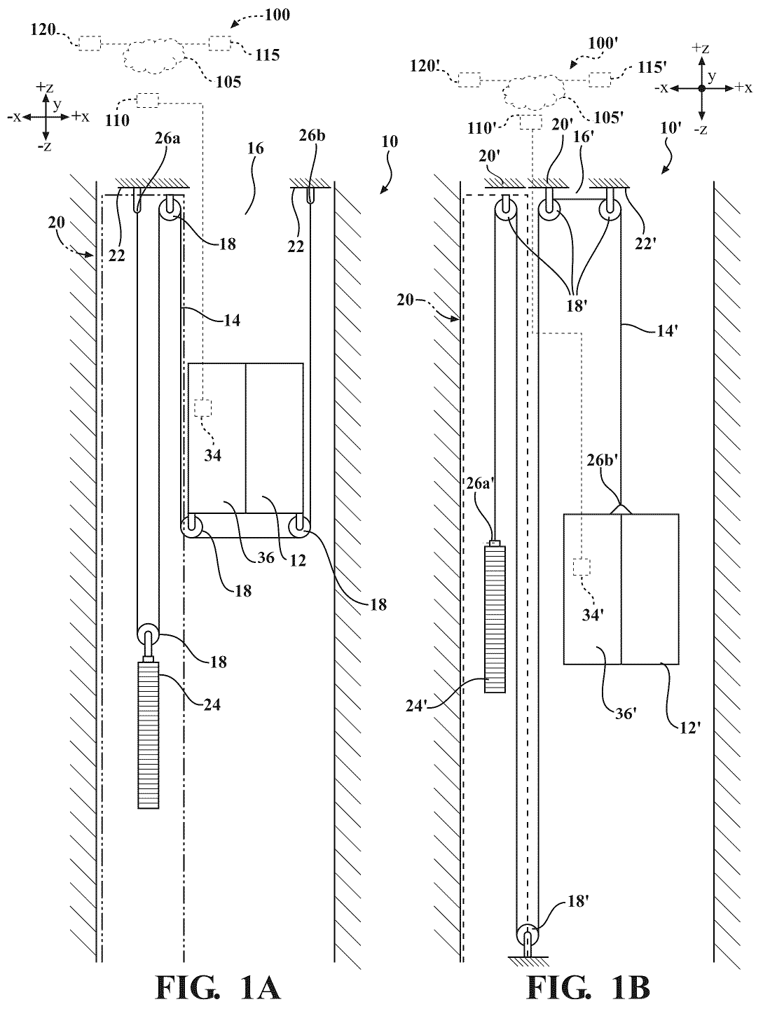

Referring now to the drawings, FIG. 1A depicts an elevator system schematic that illustrates various components for a first aspect of an example elevator system 10. In this aspect, the example elevator system 10 may include an elevator cab 12, a plurality of elevator hoisting members 14 illustrated for schematic reasons as a single suspension member and herein referred to as hoisting members, a hoistway 16 or elevator shaft, a plurality of sheaves 18, an example frame 20, and a plurality of weights 24 that act as a counterweight to the elevator cab 12. The plurality of weights 24 move within the example frame 20 in the system vertical direction (i.e., in the +/−Z direction). The example frame 20 may be an elevator frame, a counterweight elevator frame, and/or the like, as discussed in greater detail herein. The plurality of elevator hoisting members 14 include a distal end 26a and a proximate end 26b. As used herein, the elevator cab 12 may be referred to as an elevator cab.

Further, in this aspect, as illustrated and without limitation, the example frame 20 includes two sheaves of the plurality of sheaves 18. For example, one sheave is fixedly mounted to an upper portion of the example frame 20 positioned in an upper portion of the hoistway 16 above the elevator cab 12 in a vertical direction (i.e., in the +/−Z direction) and another sheave moves with the weights 24 as the elevator cab 12 moves between various landings. This is non-limiting, and any number of the plurality of sheaves 18 may be mounted anywhere within the hoistway 16 and there may be more than or less than the two sheaves illustrated as being in the example frame 20.

At least one of the plurality of sheaves 18 within the hoistway 16 may include a motor such that the sheave is a traction sheave capable of driving the plurality of elevator hoisting members 14 through a plurality of lengths between the elevator cab 12 and the traction sheave. Further, the plurality of sheaves 18 may further include a plurality of idler sheaves that may also be mounted at various positions in the hoistway 16, and, in this aspect, are also coupled to the elevator cab 12. Idler sheaves are passive (they do not drive the elevator hoisting members 14, but rather guide or route the plurality of elevator hoisting members 14) and form a contact point, or engagement point, with the elevator cab 12. The plurality of elevator hoisting members 14 and the plurality of sheaves 18 move the elevator cab 12 between a plurality of positions within the hoistway 16 including to a plurality of landings. The plurality of sheaves 18 may include any combination of traction type sheaves and idler type sheaves.

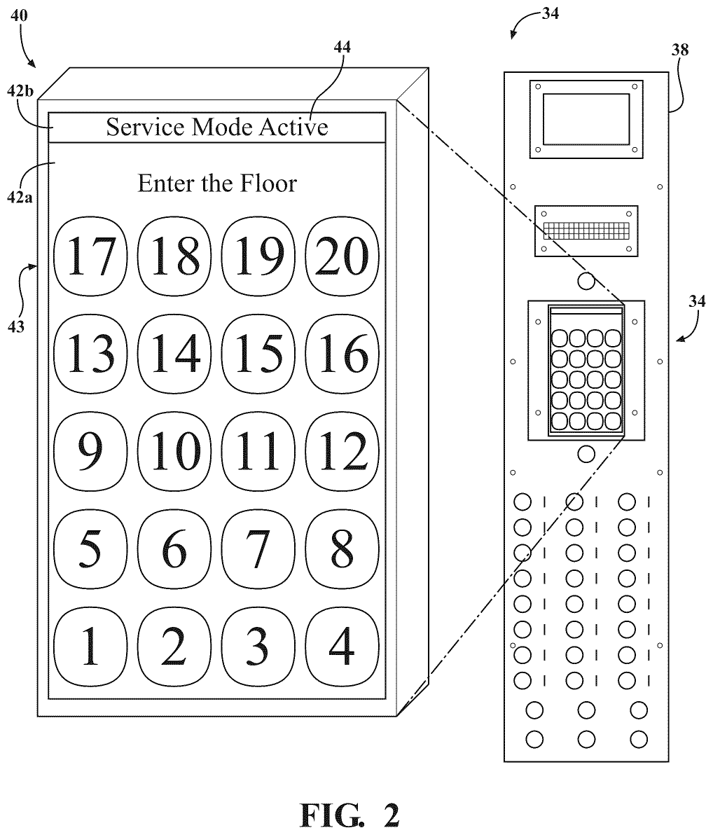

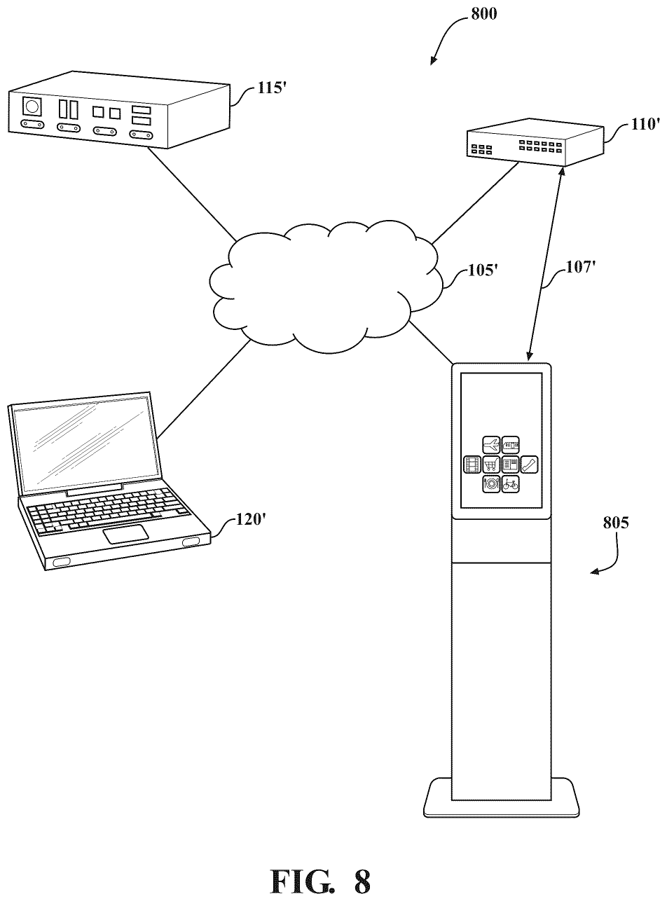

The elevator cab 12 may include at least one elevator door 36 that is configured to open and close at particular or predetermined landings. Further, in some embodiments, the elevator cab 12 may further include an in-elevator operating panel (COP) display device 34. The in-elevator COP display device 34 may include a display device 40, or monitor, various selectors 43, and other call selectors or buttons, as best illustrated in FIG. 2. The in-elevator COP display device 34 is communicatively coupled to an illustrative in-elevator display system 100, which includes the in-elevator COP display device 34, an elevator controller 110, a design-computing module 115, and a user-computing device 120, as discussed in greater detail herein. It should be understood that this arrangement is non-limiting and that a display device may also be positioned within a landing area, lobby area, and the like, to work in conjunction with the in-elevator COP display device 34 as discussed in greater detail herein. Further, in other embodiments, the in-elevator COP display device 34 may be replaced by an in-hall display device 805 as best illustrated in FIG. 8 and discussed in greater detail herein.

As illustrated in FIG. 1A, the elevator system 10 is an underslung system, with the idler sheaves positioned on a bottom surface of the elevator cab 12. Each of the plurality of elevator hoisting members 14 may be movably coupled to the traction sheave and a portion of the plurality of elevator hoisting members 14 may be coupled to the bottom surface of the elevator cab 12 to suspend the elevator cab 12 via the idler sheaves. As such, the elevator hoisting members 14 pass under the elevator cab 12 on a bottom of the elevator cab 12 via the idler sheaves, and are coupled at the top of the hoistway 16 under tension to various structures, such as to the example frame 20, a plurality of rail caps 22 (e.g., fixed structures), and/or the like. For example, the proximate end 26b of the plurality of elevator hoisting members 14 may be fixedly coupled to the rail caps 22 and the movably coupled portion of the plurality of elevator hoisting members 14 are under tension to move the elevator cab 12 between various landings. The example frame 20 may include a dead end hitch, at least one of the plurality of rail caps 22, and/or other structural components.

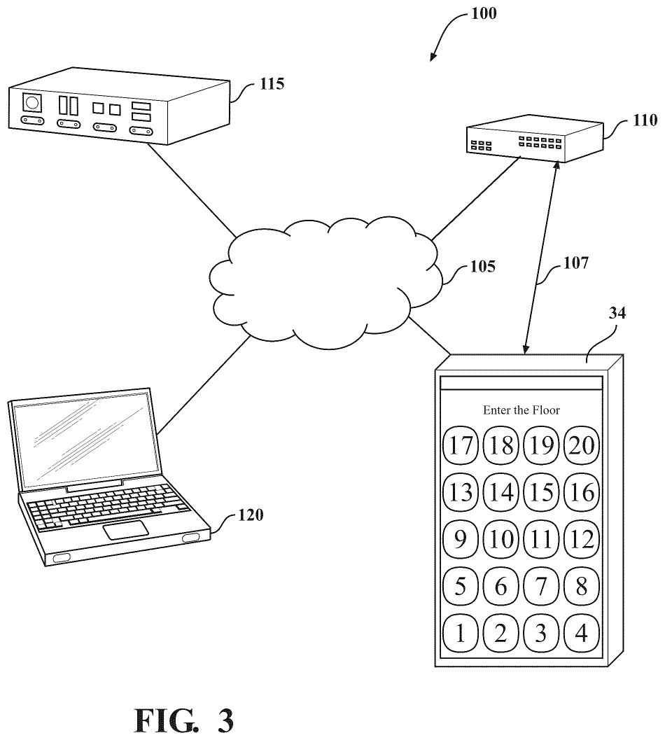

Still referring to FIG. 1A, and now also referring to FIG. 3, the illustrative in-elevator display system 100 of the elevator system 10 may include the elevator controller 110, a network interface hardware 105, the design-computing module 115, and the user-computing device 120. The elevator controller 110 may receive and transmit data from and/or to the elevator cab 12, such as the in-elevator COP display device 34, and other elevator components (e.g., each of the plurality of sheaves 18, and the like) and may control operation of the elevator system 10. For example, the elevator controller 110 may send or transmit services codes (e.g., specific elevator operation modes) and other data to the in-elevator COP display device 34. In other embodiments, the elevator controller 110 may receive data from various remote components, such as, without limitation, the in-elevator COP display device 34, the elevator controller 110, the design-computing module 115, and the user-computing device 120. In other examples, the elevator controller 110 may receive other data from the elevator cab 12 and/or other components of the elevator system 10. The elevator controller 110 may also control operation and movement of the elevator cab 12. The elevator controller 110 may also receive control signals or data from other components within or remote to the elevator system 10.

The design-computing module 115 may be configured to send customized themes or customized graphical element display information data with a customized assigned identifier such as a numeric code value to the in-elevator COP display device 34 for display by the in-elevator COP display device 34 at specific elevator system conditions, as discussed in greater detail herein. The associated graphical element display information data that is displayed by the in-elevator COP display device 34 may include letters, words, images, combinations thereof, and the like.

In some embodiments, the network interface hardware 105 may be communicatively coupled to the design-computing module 115, the in-elevator COP display device 34 and the user-computing device 120. Accordingly, the network interface hardware 105 can include a communication transceiver for sending and/or receiving any wired or wireless communication. For example, the network interface hardware 105 may include an antenna, a modem, LAN port, Wi-Fi card, WiMax card, mobile communications hardware, near-field communication hardware, satellite communication hardware and/or any wired or wireless hardware for communicating with other networks and/or devices. In other embodiments, the elevator controller 110 may be communicatively coupled to the network interface hardware 105. In this embodiment, the network interface hardware 105 may receive data about the elevator system 10 captured by the elevator controller 110 and the elevator controller 110 may communicate data with and between the other components of the in-elevator display system 100 (e.g., the in-elevator COP display device 34, the design-computing module 115, and the user-computing device 120, and the like). In other embodiments, the elevator controller 110 is communicatively coupled to the in-elevator COP display device 34 via a communication interface 107, which is independent from the network interface hardware 105. For example, utilizing CANBUS, RS485, and the like, as interfaces, the elevator controller 110 and the in-elevator COP display device 34 may transmit data and information between them via the communication interface 107. The network interface hardware 105 may also be communicatively coupled to a remote computing device, as discussed in further detail below.

Referring now to FIG. 1B, a schematic illustrating various components for a second aspect of an example elevator system 10′ is depicted. It should be appreciated that in the discussion herein, the elevator system 10, and components thereof, may refer to either elevator system 10, 10′. In this aspect, the elevator system 10′ may include an elevator cab 12′, a plurality of elevator hoisting members 14′ illustrated for schematic reasons as a single suspension member, a hoistway 16′ or elevator shaft, a plurality of sheaves 18′, such as traction sheaves and/or idler sheaves, an example grounded frame 20′, and a plurality of weights 24′ that move within the example frame 20′ in the system vertical direction (i.e., in the +/−Z direction). In this aspect, the plurality of elevator hoisting members 14′ extend a length between the weights 24′ and the elevator cab 12′. Further, in this aspect, at least one of the plurality of sheaves 18′ is a traction sheave, which, for example, may be mounted to a lower surface of the hoistway 16′. This is non-limiting, and the traction sheave of the plurality of sheaves 18′ may be mounted anywhere within the hoistway 16′ and the plurality of sheaves 18′ may include a plurality of idler sheaves and at least one traction sheave. It should be appreciated that the traction sheave may include a motor such that at least one of the plurality of sheaves 18′ is a device to drive the plurality of elevator hoisting members 14′ through a plurality of lengths with respect to the length between the traction sheave and the contact point of the elevator cab 12′. The idler sheaves may also be mounted at various positions in the hoistway 16′ including within the example frame 20′. The idler sheaves are passive (they do not drive the plurality of elevator hoisting members 14′ but rather guide or route the plurality of elevator hoisting members 14′). The plurality of elevator hoisting members 14′ are coupled to the elevator cab 12′ to form the contact point.

The elevator system 10′ may also include the in-elevator COP display device 34′ communicatively coupled to the elevator controller 110′ via the communication interface 107′, such as by utilizing CANBUS, RS485, or other communication interfaces, as discussed above. In other embodiments, the elevator controller 110′ and the in-elevator COP display device 34′ may be communicatively coupled via the network interface hardware 105′. In yet other embodiments, the elevator controller 110′ may be communicatively coupled to the network interface hardware 105′ such that the elevator controller 110′ may communicate data with and between the other components of the illustrative in-elevator display system 100, which are communicatively coupled to the network interface hardware 105′ (e.g., the in-elevator COP display device 34, the design-computing module 115, and/or the user-computing device 120).

It should be appreciated that the illustrated schematics of FIGS. 1A-1B are merely examples and that the plurality of elevator hoisting members 14 routing may vary significantly or slightly from these illustrated schematics. For example, there may be several idler sheaves positioned in the hoistway 16 between the traction sheave and the contact point with the elevator cab 12.

Referring back to FIGS. 1A and now to FIG. 3, FIG. 3 schematically depicts an in-elevator illustrative computing network that depicts components for permitting a change of a display on an in-elevator COP display device 34 without a need for a software change in the in-elevator COP display device 34, according to embodiments shown and described herein. As illustrated in FIG. 3, the example network interface hardware 105 may generally be configured to communicatively couple one or more computing devices and/or components thereof that may be positioned adjacent and/or remote from one another. Illustrative computing devices may include, but are not limited to, a user-computing device 120, the elevator controller 110, the design-computing module 115, and/or the like.

The user-computing device 120 may generally provide an interface between a user and the other components connected to the network interface hardware 105. Thus, the user-computing device 120 may be used to perform one or more user-facing functions, such as receiving one or more inputs from a user for designing or customizing graphical elements or graphical element display information such as images, messages, and/or the like, and/or transmitting data or information such as data related to a graphical data. More specifically, the user-computing device 120 may present a graphic design interface for a user to design or generate the graphical element display information data may include numbers, words, images, objects, combinations thereof, and the like, for display by the in-elevator COP display device 34 (FIG. 1A). For example, the user-computing device 120 may include a user interface configured to the graphical element display information data for display the in-elevator COP display device 34 (FIG. 1A). The graphic element information is created and stored on as a graphical data on a data respiratory of the design-computing module 115. When desired, the graphic element information is transmitted from the design-computing module 115 to the in-elevator COP display device 34 (FIG. 1A). As such, there is a significant reduction in data required to be transmitted by the elevator controller 110 or on-site programming for each in-elevator COP display device 34 (FIG. 1A), required by conventional systems. The user-computing device 120 may be used to perform one or more user-facing functions, such as transmitting and/or receiving one or more inputs or data to and/or from components of the elevator system 10, as discussed herein.

The user-computing device 120 may be, for example, a laptop, mobile phone, tablet, desktop computer, and/or the like, that is positioned at or remote to the elevator controller 110 and/or the design-computing module 115. In some embodiments, the user-computing device 120 may be configured to provide desired oversight, updating, and/or correction to other components of the elevator system 10.

The design-computing module 115 may be a central processing unit configured to generally provide an interface between the user-computing device 120 and the other components of the elevator system 10 that may be connected to the network interface hardware 105. Thus, the design-computing module 115 may be used to transform, convert, or otherwise change data to transmit data between the user-computing device 120, which may be used for designing purposes, and the in-elevator COP display device 34, which may be used to convert or change data into a format that may be displayed to passengers within the elevator cab 12 when the elevator system 10 is in specific elevator operating modes, as discussed in greater detail herein. As such, the design-computing module 115 may include the requisite processing device, hardware, software, and/or the like, to perform the functionalities relating to transmitting and/or receiving one or more inputs or data to and/or from components of the elevator system 10.

Still referring to FIGS. 1A and 3, the elevator controller 110 provides commands to the traction sheaves 18, actuators of the elevator cab 12 to open or close the doors, and/or the like. Further, the elevator controller 110 may communicate movements, landing locations, current positional information, and the like, to the in-elevator COP display device 34 for display to users positioned within the elevator cab 12. As such, the elevator controller 110 may receive data from various sensors and sources necessary to operate the elevator system 10 through sequences of operation and real-time calculations or algorithms. As such, the elevator controller 110 may contain the requisite processing device, hardware, software, and/or the like, to perform the functionalities relating to moving elevator cabs, hoisting members, traction sheaves, doors, and the like between and stopping at landings, and/or the like, generally associated with the elevator system 10.

Now referring to FIGS. 1A, 2 and 3, the in-elevator COP display device 34 may receive data from one or more sources (e.g., from the design-computing module 115, the elevator controller 110, and/or the like), and is configured to generate data, store data, index data, search data, and/or provide data to the design-computing module 115 (or components thereof), the elevator controller 110 (or components thereof), and to various components of the in-elevator COP display device 34 itself. In some embodiments, the in-elevator COP display device 34 may employ one or more algorithms that are used for the purposes of determining whether graphical element display information data, pre-stored themes or subject configurations match a display request that may be initiated by the elevator controller 110 when the elevator system 10 is in a specific operating condition.

For example, when the customized graphical element display information data to be displayed is transmitted to the in-elevator COP display device 34 there is no longer a requirement for the elevator controller 110 to transmit any graphic data. As such, this limits the amount of data (e.g., only a file name, a few bytes of data, and the like, are required or needed for identification purposes) from the elevator controller 110 to one or more processors of the in-elevator COP display device 34, which are then configured to search a data storage repository 416 of the in-elevator COP display device 34 for a plurality of pre-stored graphical element display information data, themes or subject configurations, and determine whether there is a match between one of the plurality of pre-stored graphical element display information data, themes or subject configurations, and the customized graphical element information requested to be displayed based on the service mode code value, as discussed in greater detail herein.

Now referring to FIG. 2, the in-elevator COP display device 34 is positioned within the elevator cab 12 such that a panel 38 positioned within the elevator cab 12 houses at least a portion of the in-elevator COP display device 34. The in-elevator COP display device 34 may include the display device 40 that is visible to the occupants or passengers within the elevator cab 12. The display device 40 may include various display portions that may be configured to display different information. For example, and without limitation, the display device 40 may include a first display portion 42a and a second display portion 42b. In the depicted embodiment, the first display portion 42a displays the plurality of selectors 43 corresponding to a plurality of floors or landings that the elevator cab 12 may stop to load and/or unload. The second display portion 42b may be an independent display and is configured to display the customized graphical element display information data 44, as discussed in greater detail herein.

Now referring back to FIGS. 1A, 2 and 3, the embodiments described herein improve computer functionality by permitting limited data to be transmitted between the elevator controller 110, the design-computing module 115, and the in-elevator COP display device 34 thereby reducing the amount of memory required, reduction in a data storage required, and a reduction in an amount of transmitted data that is required to be stored, evaluated, or otherwise requiring use of the elevator controller 110. Further, embodiments described herein improve computer functionality by permitting direct communication between the design-computing module 115 and the in-elevator COP display device 34, which results in reducing the amount of memory required, reduction in a data storage required, and a reduction in an amount of transmitted data that is required to be stored compared to conventional systems. Further, the embodiments described herein improve computer graphic user interfaces by permitting for customized graphical element information to be displayed on the in-elevator COP display device 34 without the requirement of additional software application and executable changes to the COP display device, such as typically required in conventional systems.

As such, embodiments described herein provide solutions to long felt needs in elevator technologies where conventional systems require substantively more amounts of data to be transferred either remotely or require a technician to physically upload new programming applications.

Additionally, it should be appreciated that the embodiments described herein provide improvements over conventional systems by eliminating the need to create new application software for supporting any new elevator service modes that is outside of the current standard modes. Further, the embodiments described herein are an improvement over conventional systems by permitting unlimited customized graphical element display information data associated with unlimited new and/or modified elevator service modes, which improves the quality of the customized graphical element display information data since custom software is not required.

Accordingly, it should be understood that the illustrative in-elevator display system 100 and components thereof (e.g., the elevator controller 110, the in-elevator COP display device 34, the design-computing module 115, the user-computing device 120, and/or the like) may gather and transform data for transmitting limited or partial data for the purposes of eliminating the need for software application changes every time it is desirable for a specific user interface for display within the elevator cab 12 to change such as based on the elevator service mode.

As such, the components of the illustrative in-elevator display system 100 transform partial or limited raw code or data received from a remote user and using various logic modules, machine learning techniques, and/or the like, and the in-elevator COP display device 34 itself searches for a matching theme or subject configuration for display, as discussed in greater detail herein. Such techniques improve the amount of data needed to transmit between various devices, the amount of data that must be stored on several different devices, reduces the amount of memory dedicated for software application changes, and the time required to build individual application changes for each elevator cab 12 within an elevator system 10, as discussed in greater detail herein.

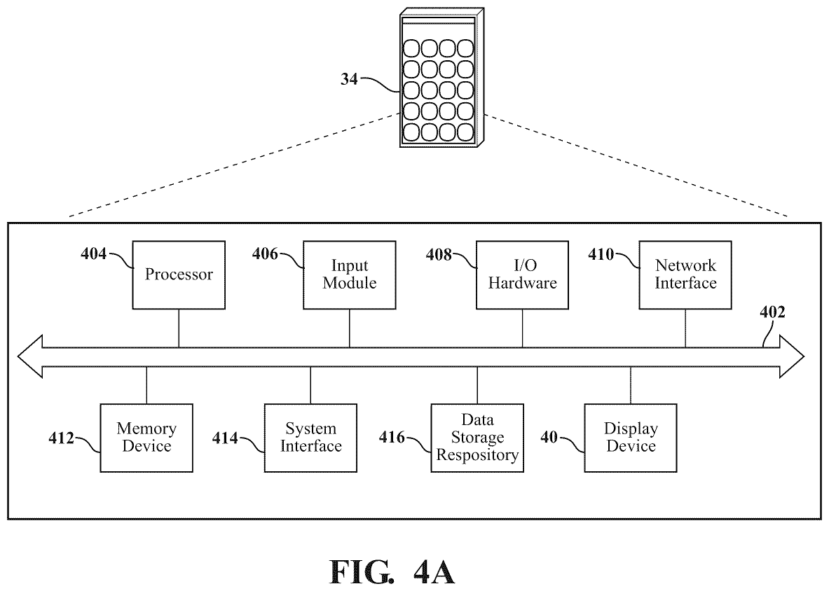

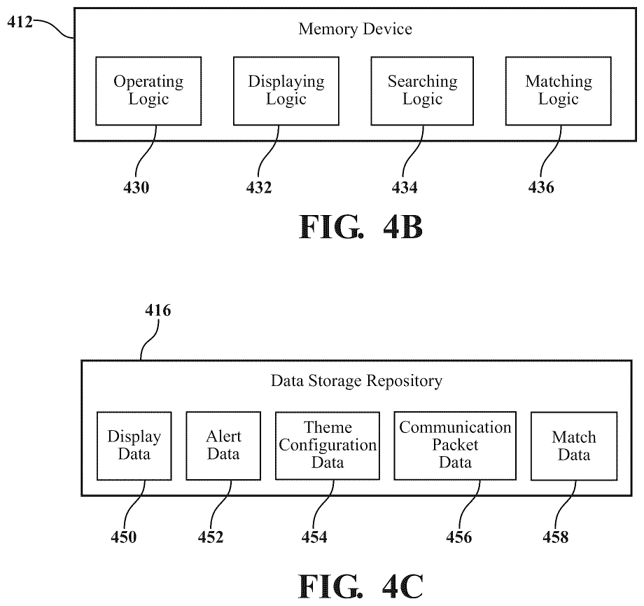

It should be appreciated that the elevator controller 110 may include the structure components and function similar to, or as the design-computing module 115, such that the elevator controller 110 performs some or all of the functionality of the design-computing module 115, as discussed in greater detail herein. The components and functionality of the in-elevator COP display device 34 will be set forth in detail below with respect to FIGS. 4A-4C.

It should also be understood that while the user-computing device 120 is depicted as a personal computer, the elevator controller 110 is depicted as a generic controller, the design-computing module 115 is depicted as a generic hub controller, and the in-elevator COP display device 34 is depicted as a generic display device with a keypad, these are merely examples. More specifically, in some embodiments, any type of computing device (e.g., mobile computing device, personal computer, server, computing device with a central processing unit and data storage, and the like) may be utilized for any of these components. Additionally, while each of these computing devices is illustrated in FIG. 3 as a single piece of hardware, this is also an example. More specifically, each of the user-computing device 120 is depicted as a personal computer, the elevator controller 110 is depicted as a generic controller, the design-computing module 115 is depicted as a generic hub controller, and the in-elevator COP display device 34 may represent a plurality of computers, servers, databases, and the like.

In addition, it should be understood that while the embodiments depicted herein refer to a network of computing devices, the present disclosure is not solely limited to such a network. For example, in some embodiments, the various processes described herein may be completed by a single computing device, such as a non-networked computing device or a networked computing device that does not use the network to complete the various processes described herein.

FIG. 4A depicts the in-elevator COP display device 34, further illustrating a system that permits a change of a data that is a visual graphic on the display device 40 of the in-elevator COP display device 34 without a need for a software change in the in-elevator COP display device 34 by utilizing hardware, software, and/or firmware, according to embodiments shown and described herein. The in-elevator COP display device 34 may include a non-transitory, computer readable medium configured for searching a data repository and determining whether a limited data received is a match to a pre-saved theme configurations or subject matter embodied as hardware, software, and/or firmware, according to embodiments shown and described herein.

While in some embodiments, the in-elevator COP display device 34 may be configured as a general-purpose computer with the requisite hardware, software, and/or firmware, in other embodiments, the in-elevator COP display device 34 may be configured as a special purpose computer designed specifically for performing the functionality described herein. For example, the in-elevator COP display device 34 may be a specialized device that particularly receives a communication packet that includes a service mode code value (e.g., from the elevator controller 110), which is a limited data command or packet that is associated with a graphical element display information that is desired to be displayed by the in-elevator COP display device 34 (e.g., the service mode code value or the communication packet data is reduced data size that is significantly less data size than the original data size, such as the the graphic element display information). In response, the in-elevator COP display device 34 may search the data repository for a plurality of pre-stored graphical element display information data or theme configurations that include a unique identifier, such as numeric code value that may match or correlate with the service mode code value.

In a further example, the in-elevator COP display device 34 may be a specialized device that further determines whether there is a match between at least one of the plurality of pre-stored graphical element display information data (e.g., the identifier) and the service mode code value. The in-elevator COP display device 34, upon determination that there is a match, then displays the at least one of the pre-stored graphical element display information data that matches the service mode code value with various pre-stored graphical data (e.g., numbers, letters, words, objects, images, pages, combinations thereof, and/or the like) on the display device 40 (FIG. 2) of the in-elevator COP display device 34 (FIG. 2) for the purposes of improving computer functionality by reducing the amount of data transmitted between external computer devices, by reducing the amount of memory and processing required, by reducing the amount of bandwidth needed to transmit, and to improve computer graphic user interfaces by permitting for customized graphical element information to be displayed by the in-elevator COP display device 34 (FIG. 2) without the requirement of additional software changes to the in-elevator COP display device 34 (FIG. 2).

As also illustrated in FIG. 4A, the in-elevator COP display device 34 may include one or more processors 404, an input module 406, input/output hardware 408, network interface hardware 410, a memory device 412, a system interface 414, and a data storage repository 416. A local interface 402 is also included in FIG. 4A and may be implemented as a bus or other interface to facilitate communication among the components of the in-elevator COP display device 34.

The one or more processors 404 may be a computer processing unit (CPU) and include any processing component(s) configured to receive and execute instructions (such as from the data storage repository 416 and/or memory device 412). The one or more processors 404, alone or in conjunction with the other components, is an illustrative processing device, computing device, or combination thereof.

The input module 406 may include tactile input hardware (i.e. a joystick, a knob, a lever, a button, a touchscreen, and the like) that allows the passenger of the elevator cab 12 (FIG. 1A) to input destinations and other settings such as audible indicators, and the like. In some embodiments, a button or other electrically coupled input device may be disposed within the in-elevator COP display device 34 and may be communicatively coupled to the illustrative in-elevator display system 100 (FIG. 1A) such that when the button or other input device is activated (i.e., touched, moved, etc.), the processor 404 executes logic stored on the memory device 412 to transmit desired floor selections or other data to the elevator controller 110 (FIG. 1A). It should be appreciated that the input device may be a keyboard, a mouse, a joystick, a touch screen, a remote control, a pointing device, a video input device, an audio input device, a haptic feedback device, and/or the like.

The input/output hardware 408 may communicate information between the local interface 402 and one or more other components of the in-elevator COP display device 34. For example, the I/O hardware 408 may act as an interface between the in-elevator COP display device 34 and other components, such as the display device 40, and/or the like. In some embodiments, the I/O hardware 408 may be utilized to transmit one or more commands to the other components of the elevator system 10 (FIG. 1A).

The network interface hardware 410 may include any wired or wireless networking hardware, such as a modem, LAN port, wireless fidelity (Wi-Fi) card, WiMax card, mobile communications hardware, and/or other hardware for communicating with other networks and/or devices. For example, the network interface hardware 410 may provide a communications link between the in-elevator COP display device 34 and the other components of the illustrative in-elevator display system 100 depicted in FIG. 1A, including, but not limited to the design-computing module 115. In other examples, the network interface hardware 410 may be configured with the appropriate hardware to interact with other interfaces, such as, without limitation, CANBUS, RS485, and the like, to communicatively couple the in-elevator COP display device 34 and the elevator controller 110.

The system interface 414 may generally provide the in-elevator COP display device 34 with an ability to interface with one or more external devices such as, for example, the elevator controller 110, the design-computing module 115, the user-computing device 120 and the like, depicted in FIG. 1A. Communication with external devices may occur using various communication ports (not shown). An illustrative communication port may be attached to the network interface hardware 105.

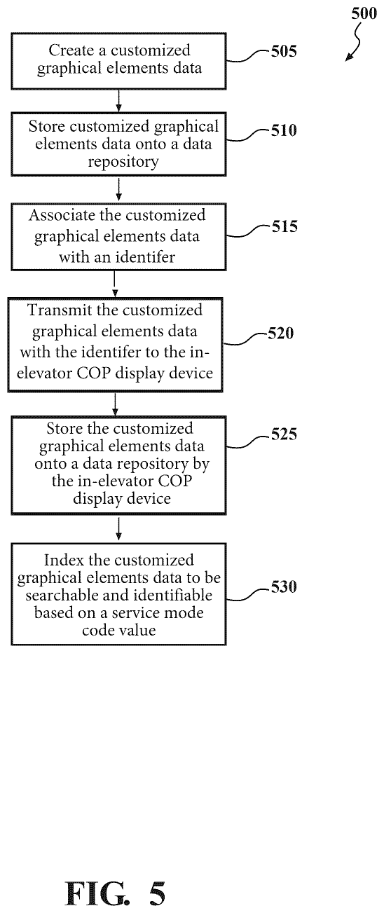

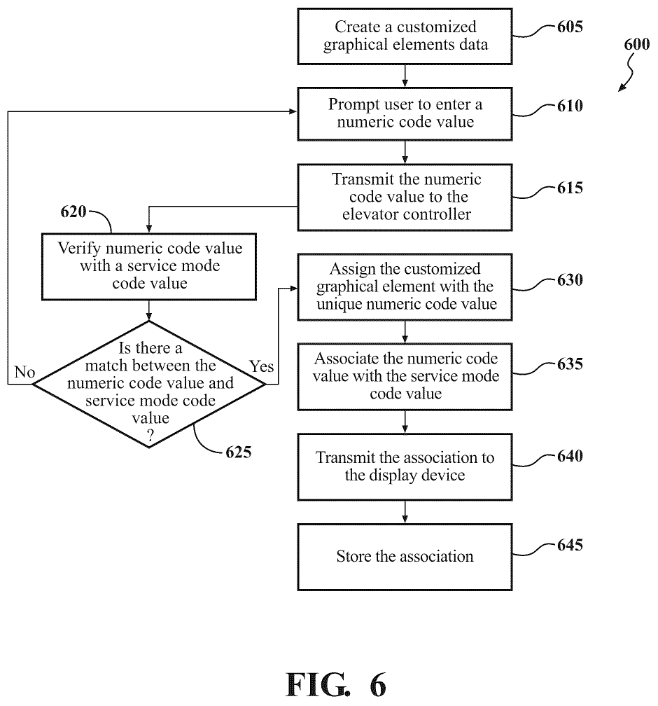

The memory device 412 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. The memory device 412 may include one or more programming instructions thereon that, when executed by the processor 404, cause the processor 404 to complete various processes, such as the processes described herein with respect to FIGS. 5-6. Still referring to FIG. 4A, the programming instructions stored on the memory device 412 may be embodied as a plurality of software logic modules, where each logic module provides programming instructions for completing one or more tasks, as described in greater detail below with respect to FIG. 4B.

Still referring to FIG. 4A, the data storage repository 416, which may generally be a storage medium or storage device, may contain one or more data repositories for storing data that is received and/or generated. The data storage repository 416 may be any physical storage medium, including, but not limited to, a hard disk drive (HDD), memory, removable storage, and/or the like. While the data storage repository 416 is depicted as a local device, it should be understood that the data storage repository 416 may be a remote storage device, such as, for example, a server-computing device or the like, and may be configured to store one or more pieces of data for access by the in-elevator COP display device 34 and/or other components of the illustrative in-elevator display system 100 (FIG. 1A). Illustrative data that may be contained within the data storage repository 416 is described below with respect to FIG. 4C. Further, the data storage repository may be cloud based, web based, and the like.

Still referring to FIG. 4A, the display device 40 may be communicatively coupled to the local interface 402 and communicatively coupled to the processor 404 via the local interface 402. The display device 40 may permit information from the local interface 402 to be displayed on the first display portions 42a and the second display portion 42b (FIG. 2) of the display device 40 in audio, visual, graphic, alphanumeric format, and/or the like. In some embodiments, the display device 40 may include its own processor, which may also be communicatively coupled to the local interface 402 and may be communicatively coupled to the processor 404 and/or the memory device 412 via the local interface 402. Moreover, the display device 40 may interface with the input module 406 to include the one or more inputs on the first display portions 42a and the second display portion 42b (FIG. 2) such as the touchscreen having a plurality of user controls, as discussed in greater detail herein.

With reference to FIG. 4B, in some embodiments, the program instructions contained on the memory device 412 may be embodied as a plurality of software modules, where each module provides programming instructions for completing one or more tasks. For example, FIG. 4B schematically depicts the memory device 412 containing illustrative logic components according to one or more embodiments shown and described herein. As shown in FIG. 4B, the memory device 412 may be configured to store various processing logic, such as, for example, operating logic 430, displaying logic 432, searching logic 434, and matching logic 436 (each of which may be embodied as a computer program, firmware, or hardware, as an example). The operating logic 430 may include an operating system and/or other software for managing components of the in-elevator COP display device 34 (FIG. 4A). Further, the operating logic 430 may contain one or more software modules for receiving data, transmitting data, generating data, and/or analyzing data.

Still referring to FIG. 4B, the displaying logic 432 may contain one or more software modules for receiving data from one or more sources (e.g., the elevator controller 110, the design-computing module 115 depicted in FIG. 1A, and/or the like) and/or converting data into a display, such as a numbers, letters, words, objects, images, pages, themes, combinations thereof, and/or the like, as described in greater detail herein. Moreover, the displaying logic 432 may process the data extracted from the data storage repository 416 so to change the second display portion 42b with the desired graphic elements data obtained from the plurality of pre-stored theme configurations.

The searching logic 434 may contain one or more software modules for gathering and analyzing the external data (e.g., the service mode code value, the numeric code value, and/or the communication packet that may include or otherwise be associated with the service mode code value, which is a limited data packet that is associated with the graphic elements data that is desired to be displayed by the in-elevator COP display device 34, in which the communication packet data is reduced significantly from the graphic elements data) and searches the data storage repository 416 for a plurality of pre-stored theme configurations or subjects that are assigned with a unique in-cab numeric code value that may match the service mode code value. As discussed in greater detail herein, the service mode code value may be a predetermined data value based on operating conditions of the elevator system 10 (FIG. 1A) and the service mode code value may be generated and/or transmitted by the elevator controller 110, as discussed in greater detail herein. This is non-limiting and any component of the illustrative in-elevator display system 100 (e.g., the design-computing module 115, and the user-computing device 120, combinations thereof, and/or the like) may generate and/or transmit the service mode code value.

The searching logic 434 may search any data repository, whether cloud based data repository, web based data repository, and/or a physical repository device, to search through a pre-stored theme configurations or subjects for a specific desirable display data that may be initiated remote from the in-elevator COP display device 34 by any component of the illustrative in-elevator display system 100 (e.g., the elevator controller 110, the design-computing module 115, the user-computing device 120, combinations thereof, and/or the like). The searching logic 434 may further retrieve and provide the data of the pre-stored theme configuration or subject for the specific desirable graphical element display for display by the in-elevator COP display device 34.

The matching logic 436 may contain one or more software modules for evaluating or determining whether the search of the plurality of pre-stored theme configurations or subjects stored on the data storage repository 416 matches the desired graphic data based on, in a non-limiting example, the service mode code value assigned to communication packet to identify the desired graphic data to be displayed. The service mode code value may be assigned to or associated with the communication packet, which identifies the desired graphic data, but at a much smaller data size of footprint, by any component of the illustrative in-elevator display system 100 (e.g., the elevator controller 110, the design-computing module 115, the user-computing device 120, a combination thereof, and/or the like). As such, in some embodiments, the communication packet associated with the service mode code value may have been previously transmitted to the in-elevator COP display device 34 and stored in the data repository for indexing, searching, and recalling for the specific communication packet that includes the desired graphical elements to be displayed based on the service mode code value.

In other embodiments, the elevator controller 110 may transmit only the service mode code value, which is indicative of a current operating mode or condition of the elevator system 10 (FIG. 1A) to the in-elevator COP display device 34. In response, the matching logic 436 may be configured to determine whether the service mode code value matches with the unique in-cab numeric value that is assigned. For example, whether the service mode code value and the unique in-cab numeric value match or correlate with a file name for of at least one of the plurality of pre-stored theme configurations or subjects. When the match is determined, the matching logic 436 may instruct the processor 404 (FIG. 4A), the displaying logic 432, and/or the searching logic 434 of a successful match.

FIG. 4C schematically depicts a block diagram of various data contained within a storage device (e.g., the data storage repository 416). It should be understood that the data storage repository 416 may reside local to and/or remote from the in-elevator COP display device 34 and may be configured to store one or more pieces of data for access by the in-elevator COP display device 34 and/or other components. As illustrated in FIG. 4C, the data storage repository 416 may include, for example, a display data 450, an alert data 452, a theme configuration data 454, a communication packet data 456, and a match data 458.

The display data 450 may store a plurality of data relating to the type, size, location, and the like, of the display device 40, the communication path or routes, and other data required to transmit data to and from the display device 40 for the purposes of displaying the desired customized graphical element information data. The display data 450 may further store a plurality of data related to the desired graphic elements data that is concurrently in display, will be displayed, and the like. As such, the plurality of data related to the desired customized graphical element information data may be data already confirmed to be a match between the communication packet (e.g., the numeric code value and/or the service mode code value) and at least one of the plurality of theme configurations to display the desired graphic data.

The alert data 452 may store a plurality of data relating to various unique codes (e.g., the service mode code values) associated with various elevator modes. As such, the alert data may include a plurality of data received from the elevator controller 110 (FIG. 3) relating to a plurality of different elevator modes and each mode may have a unique service mode code value assigned thereto. As such, each of the plurality of different elevator modes may have a unique, or independent, code (e.g., service mode code value) generated by the elevator controller 110 (FIG. 3) that is stored within the alert data 452. It should be understood that the data stored in the alert data 452 may change at discrete intervals or continuously update and/or change based on the operating condition and/or mode of the elevator system 10 (FIG. 1A).

The theme configuration data 454 may store a plurality of graphic elements such as specific in-elevator theme configurations that are desirable to be displayed based on the elevator operating modes. The plurality of theme configurations may be pre-programmed and/or pre-stored and be recalled based on the based on the service mode code value and/or the unique in-cab numeric code that is assigned to each of the plurality of theme configurations when stored in the theme configuration data 454. The plurality of theme configurations may include visual data, GUI data, graphical element data, combinations thereof, and the like.

The communication packet data 456 may store a plurality of data relating to the desired communication packet for display that may be generated and/or transmitted by any component of the illustrative in-elevator display system 100 (e.g., the elevator controller 110, the design-computing module 115, and the user-computing device 120, combinations thereof, and/or the like) and may be triggered to be displayed by the elevator controller 110 based on the current service mode of the elevator system 10 (FIG. 1A). The communication packet includes or has encoded therein, or is otherwise associated with a plurality of data including the numeric code value and/or the service mode code value. The numeric code value and/or service mode code value may then be matched with the at least one of the plurality of theme configurations such that the matched theme configuration may be displayed on the display device 40 without the need for additional software changes to support the display of the graphical element display information data in this new service mode and with minimal data transfer between the components of the illustrative in-elevator display system 100 (e.g., the elevator controller 110, the design-computing module 115, and the user-computing device 120, combinations thereof, and/or the like)) and the in-elevator COP display device 34 (FIG. 2), as discussed in greater detail herein.

The match data 458 may store a plurality of data related to whether the service mode code value of the transmitted desired communication packet matches at least one of the plurality of theme configurations based on a match between the service mode code value of the transmitted desired communication packet and the unique in-cab numeric code of the at least one of the plurality of theme configurations. A match may indicate that there is a matching theme for the specific elevator service mode for displaying the desired graphical element display information data by the in-elevator COP display device 34.

It should be understood that the components illustrated in FIGS. 4A-4C are merely illustrative and are not intended to limit the scope of this disclosure. More specifically, while the components in FIGS. 4A-4C are illustrated as residing within the in-elevator COP display device 34, this is a non-limiting example. In some embodiments, one or more of the components may reside external to the in-elevator COP display device 34 and/or the elevator system 10 (FIG. 1A). Similarly, as previously described herein, while FIGS. 4A-4C are directed to the in-elevator COP display device 34, other components such as the elevator controller 110 (FIG. 1A), the design-computing module 115 (FIG. 1A), and the like, may include similar hardware, software, and/or firmware.

As mentioned above, the various components described with respect to FIGS. 4A-4C may be used to carry out one or more processes and/or produce data that can improve a user interface by displaying a limited set of data related to desired graphical element display information data without the need to additional software programming. Further, the various components described with respect to FIGS. 4A-4C may be used to carry out one or more processes and/or produce data that can improve a computer functionality by reducing the amount of memory required, reduction in a data storage required, and a reduction in an amount of transmitted data that is required to be stored on the elevator controller and/or the design-computing module, and transmitted between the elevator controller 110 (FIG. 3), the design-computing module 115 (FIG. 3), and/or the in-elevator COP display device 34 (FIG. 2).

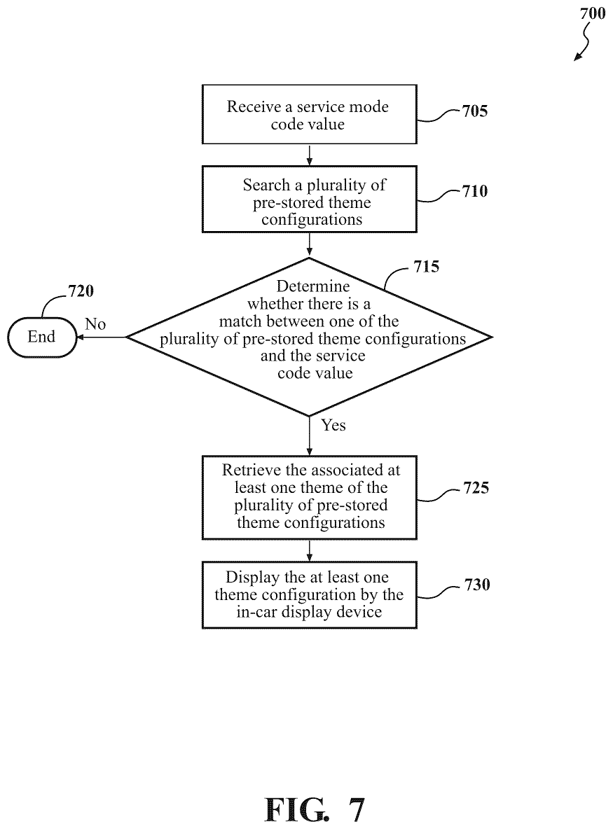

Referring now to FIG. 5, which depicts a flow diagram that graphically depicts a first illustrative method 500 for generating and storing customized graphical element display information data without the need for further software or application programming is provided. Although the steps associated with the blocks of FIG. 5 will be described as being separate tasks, in other embodiments, the blocks may be combined or omitted. Further, while the steps associated with the blocks of FIG. 5 will described as being performed in a particular order, in other embodiments, the steps may be performed in a different order and may be continuously performed or performed at discrete intervals. Further, the steps associated with the blocks of FIG. 5 may be simultaneously performed with, in combination with, or independent from the other processes associated with FIGS. 6-7.

At block 505, a customized graphical element information data is created by using a user-computing device to access a design-computing module. The design-computing device and/or the user-computing device may utilize a web-based design tool, or other tool, which may be on premise, may be within the display device, may be a hybrid combination of thereof, or other known methods, to design or create the customized graphical element display information data. The customized graphical element display information data may include a plurality of theme, configurations and/or graphical elements (e.g., words, letters, numbers, images, combinations thereof, and the like).

At block 510, the customized graphical element display information data may be saved or stored onto a data repository, such as the data repository of the design-computing device. At block 515, the customized graphical element display information data may be saved with an identifier such as a numeric code value that may be assigned to customized graphical element display information data for searching or otherwise distinguishing each of a plurality of customized graphical element display information data. The numeric code value may further be associated with a service mode code value, as discussed in detail herein.

At block 520, the stored customized graphical element display information data may be transmitted from the design-computing device to the in-elevator COP display device and is stored by the in-elevator COP display device, at block 525. At block 530, the stored customized graphical element display information data may be indexed or otherwise stored to be searchable by the in-elevator COP display device, or components thereof, for an association with the service mode code value transmitted by the elevator controller to the in-elevator COP display device, as discussed in greater detail herein.

Referring now to FIG. 6, which depicts a flow diagram that graphically depicts a second or alternative illustrative method 600 for assigning a customized graphical element display information data to an elevator operating condition without the need for further software or application programming is provided. Although the steps associated with the blocks of FIG. 6 will be described as being separate tasks, in other embodiments, the blocks may be combined or omitted. Further, while the steps associated with the blocks of FIG. 6 will described as being performed in a particular order, in other embodiments, the steps may be performed in a different order and may be continuously performed or performed at discrete intervals. Further, the steps associated with the blocks of FIG. 6 may be simultaneously performed with, in combination with, or independent from the other processes associated with FIGS. 5 and 7.

At block 605, a customized graphical element display information data is created by using a user-computing device to access a design-computing module. The design-computing device and/or the user-computing device may utilize a web-based design tool, or other tool, which may be on premise, may be within the display device, may be a hybrid combination of thereof, or other known methods, to design or create the customized graphical element display information data (e.g., numbers, letters, words, objects, images, pages, combinations thereof, and/or the like). At block 610, the user is prompted to enter a numeric code value. At block 615, the numeric code value may be transmitted to an elevator controller via the design-computing device. The elevator controller may be positioned remote from the user-computing device and/or from the design-computing device. In a non-limiting example, the elevator controller may be positioned within a machine room or other secluded space within a building that houses the elevator system. At block 620, the elevator controller verifies that the numeric code value associated with the customized graphical element display information data is available for assignment and that the numeric code value may be associated with a service mode code value that is stored within and/or generated by the elevator controller. At block 625, the elevator controller confirms that the numeric code value and the service mode code value are identical or match. If, at block 625, it is confirmed that the numeric code value and the service mode code value differ, then the method 600 returns to block 610 to prompt the user to enter another new numeric code value. If, at block 625, the elevator controller confirms that the numeric code value and the service mode code value are identical, then at block 630, the customized graphical element display information data is assigned the numeric code value by the design-computing device.

At block 635, the process 600 continues to perform an association between the numeric code value assigned to the customized graphical element information data and the service mode code value such that the customized graphical element information data may be requested for display by either the service mode code value or the numeric code value (e.g., used as an instruction to execute the customized graphical element information data for display by the display device), and transmit to the display device, at block 640. At block 645, the display device stores the association between the customized graphical element information data and the assigned the numeric code value that may be executed by either the service mode code value or the numeric code value with a data repository for retrieval at a later time.

Referring now to FIG. 7, which depicts a flow diagram that graphically depicts a an illustrative method 700 for displaying a customized graphical element information on the in-elevator COP display device without the need for further software or application programming is provided. Although the steps associated with the blocks of FIG. 7 will be described as being separate tasks, in other embodiments, the blocks may be combined or omitted. Further, while the steps associated with the blocks of FIG. 7 will described as being performed in a particular order, in other embodiments, the steps may be performed in a different order and may be continuously performed or performed at discrete intervals. Further, the steps associated with the blocks of FIG. 7 may be simultaneously performed with, in combination with, or independent from the other processes associated with FIGS. 5-6.

At block 705, the in-elevator COP display device receives a service mode code value from the elevator controller. The service mode code value is a request from the elevator controller to the display device to display a graphical element display information that is currently desirable based on the operating conditions of the elevator system. At block 710, upon receiving the service mode code value, one or more processors of the in-elevator COP display device search a data storage repository that stores a plurality of pre-stored graphical element display information data, each includes an identifier. Each identifier for each of the graphical element display information data may be associated with the service mode code value. As such, it should be understood that instead of, or rather than, the elevator controller sending the actual customized graphical element display information data, which is a large amount of data requiring large bandwidth and additional software application programming, significant less data is actually transmitted that is associated with, or correlated to the current service mode of the elevator system and the in-hall display device itself searches the data storage repository to then obtain the data for the desired graphical element display information data associated with the service mode of the elevator system for display by the in-elevator COP display device. That is, the identifier for each of the plurality of pre-stored graphical element display information data are associated with the service mode code value generated by the elevator controller. As such, based on real-time operating conditions, the in-hall display device may display, in real time, different or customized graphical element display information data (e.g., numbers, letters, words, objects, images, pages, combinations thereof, and/or the like).

At block 715, the one or more processors of the in-elevator COP display device determines whether there is a match between the request and at least one of the plurality of pre-stored graphical element display information data. For example, the match could be with identifier (e.g., the in-cab numerical value associated with each one of the plurality of pre-stored graphical element display information data) and the service mode code value. This is non-limiting and other matches or determinations may be made between the identifier of each one of the plurality of pre-stored theme configurations, and the service mode code value. If there is not a match, then the method 700 ends, at block 720. If a match is determined at block 715, then the associated or matching at least one graphical element display information data of the plurality of pre-stored graphical element display information data is retrieved by the in-elevator COP display device, at block 725, and the at least one graphical element display information data of the plurality of pre-stored graphical element display information data is displayed, at block 730, by the display device of the in-elevator COP display device. As such, the elevator controller may request for the desired graphical element display information to be displayed by providing a service mode code value to the in-elevator COP display device.

That is, it should be understood that instead of, or rather than, sending the actual customized graphical element display information data, which is a large amount of data requiring large bandwidth and additional software application programming, between the elevator controller and other components of the in-elevator display system, significant less data is actually transmitted that is associated with, or correlated to the current service mode of the elevator system. As such and in response to receiving the service mode code value, the in-elevator COP display device itself searches the data storage repository to then obtain the customized graphical element display information data for the desired display of the graphical element display information associated with the service mode of the elevator system for display by the in-elevator COP display device. That is, the identifier is associated with the service mode code value generated by the elevator controller to correlate to the current service mode of the elevator system such that the in-elevator COP display device displays real time graphical information or desired graphical element display information data (e.g., numbers, letters, words, objects, images, pages, combinations thereof, and/or the like) that are desired for each specific service mode of the elevator system.

Referring back to FIG. 1A and now to FIG. 8, in which FIG. 8 schematically depicts an illustrative in-hall computing network that depicts components for a second aspect of an illustrative in-hall display system 800 for permitting a change of a display on an in-hall display device 805 without a need for a software change in the in-hall display device, according to embodiments shown and described herein. It is understood that the illustrative in-hall display system 800 is similar to the illustrative in-elevator display system 100 with the exceptions of the features described herein. As such, like features will use the same reference numerals with a suffix “′” for the reference numbers. As such, for brevity reasons, these features will not be described again.

As illustrated in FIG. 8, the example network interface hardware 105′ may generally be configured to communicatively couple one or more computing devices and/or components thereof that may be positioned adjacent and/or remote from one another. Illustrative computing devices may include, but are not limited to, the user-computing device 120′, the elevator controller 110′, the design-computing module 115′, the in-hall display device 805, and/or the like.

The user-computing device 120′ may generally provide an interface between a user and the other components connected to the network interface hardware 105′. Thus, the user-computing device 120′ may be used to perform one or more user-facing functions, such as receiving one or more inputs from a user for designing or customizing graphical elements such as images, messages, and/or the like, and/or transmitting data or information such as data related to a graphical data. More specifically, the user-computing device 120′ may present a graphic design interface for a user to design or generate customized graphical display information such as messages, images, objects, combinations thereof, and the like, for display by the in-hall display device 805, which reproduces the graphical message without the need to actually transmit the significant amount of data related to the message.

The design-computing module 115′ may be a central processing unit configured to generally provide an interface between the user-computing device 120′ and the other components of the elevator system 10 that may be connected to the network interface hardware 105′. Thus, the design-computing module 115′ may be used to transform, convert, or otherwise change data to transmit data between the user-computing device 120′, which may be used for designing purposes, and the in-hall display device 805, which may be used to convert or change data into a format that may be displayed to persons in a lobby and/or landing area when the elevator system 10 is in specific elevator operating modes, as discussed in greater detail herein. As such, the design-computing module 115′ may include the requisite processing device, hardware, software, and/or the like, to perform the functionalities relating to transmitting and/or receiving one or more inputs or data to and/or from components of the elevator system 10.

The elevator controller 110′ may communicate movements, landing locations, current positional information, and the like, to the in-hall display device 805 for display to persons in the lobby and/or landing area, based on the current operation mode of the elevator cab 12. Accordingly, the in-hall display device 805 may receive data from one or more sources (e.g., from the design-computing module 115′, the elevator controller 110′, the user-computing device 120′, and/or the like), and is configured to generate data, store data, index data, search data, and/or provide data to the design-computing module 115′ (or components thereof), the elevator controller 110′ (or components thereof), and to various components of the in-hall display device 705 itself. In some embodiments, the in-hall display device 805 may employ one or more algorithms that are used for the purposes of determining whether pre-stored theme or subject configurations that match a display request that may be initiated by the elevator controller 110′, the design-computing module 115′, the user-computing device 120′, and/or other components of the elevator system 10 when the elevator system 10 is in a specific operating condition.

For example, when the customized graphical element display information to be displayed is transmitted to the in-hall display device 805 by a limited amount of data (e.g., only a file name, a few bytes of data, and the like, are required or needed for identification purposes), one or more processors of the in-hall display device 805 may be configured to search a data repository for a plurality of pre-stored theme or subject configurations, determine whether there is a match between one of the plurality of pre-stored theme or subject configurations, and the customized graphical element display information based on the limited amount of data that is actually transmitted between components, and upon a determination that there is a match, display the customized graphical element display information on the display of the in-hall display device 805, as discussed in greater detail herein.

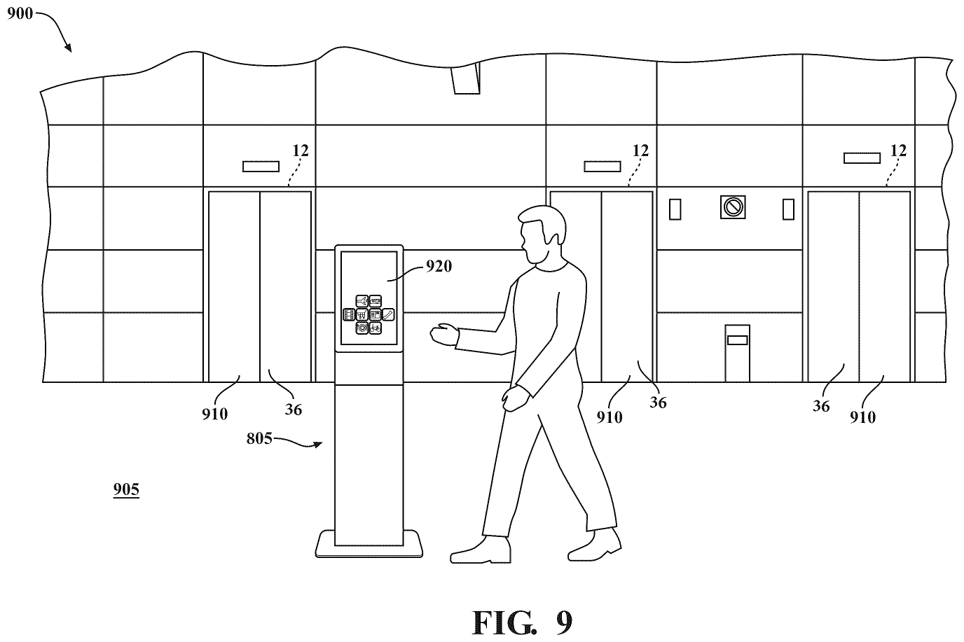

Referring now to FIG. 9 in which a partial environmental view of an example lobby 900 of a current floor 905 (i.e., call floor) of a building is schematically depicted. Further depicted are a plurality of elevator cabs 12 with their respective door 910 in a closed position. The in-hall display device 805, depicted as a kiosk, is also positioned in the example lobby 900. It should be appreciated that this is merely an example and the in-hall display device 805 may be positioned on any floor in any type of building and not necessarily positioned in the example lobby 900. Furthermore, the in-hall display device 805 may be such loosely defined to include any accessible inputs ranging from a physical station to a mobile application loaded into a smartphone, tablet, personal computer, smart watch, and/or the like. As such, the in-hall display device 805 is not limited to a kiosk and may be, either independently or in conjunction with other components, any type of display that is capable and configured to perform the functionality as described herein.

Still referring to FIG. 9, the in-hall display device 805 may include a notification device 920. The notification device 920 may be a display device, an audible device, and/or a tactile device. That is, it should be understood that the notification device 920 may include a display device, an audible device, a tactile device and/or combinations thereof.

It should be understood that the in-hall display device 805 may include all of the components of the in-elevator COP display device 34 (FIGS. 4A-4C) and is configured to perform the functionality as described herein (e.g., the illustrative methods of FIGS. 5-6). That is, the in-hall display device 805 may include the processor 404, the input module 406, the input/output hardware 408, the network interface hardware 410, the memory device 412, the system interface 414, and the data storage repository 416. The local interface 402 may also be implemented as a bus or other interface to facilitate communication among the components of the in-hall display device 805. As such, the functionality of the various components need not to be described again.

In some embodiments, the in-hall display device 805 and the in-elevator COP display device 34 (FIG. 1A) are not mutually exclusive and may be implemented together to function simultaneously in the elevator system 10 (FIG. 1A). In embodiments, a similar graphical element may be displayed by both the in-hall display device 805 and the in-elevator COP display device 34. This is non-limiting, different messages or graphical elements may be displayed by the in-elevator COP display device 34 and the in-hall display device 805. As such, the messages displayed may be based on the audience (e.g., persons within the elevator cab 12 (FIG. 1A) and persons in the lobby 900 or landing area).

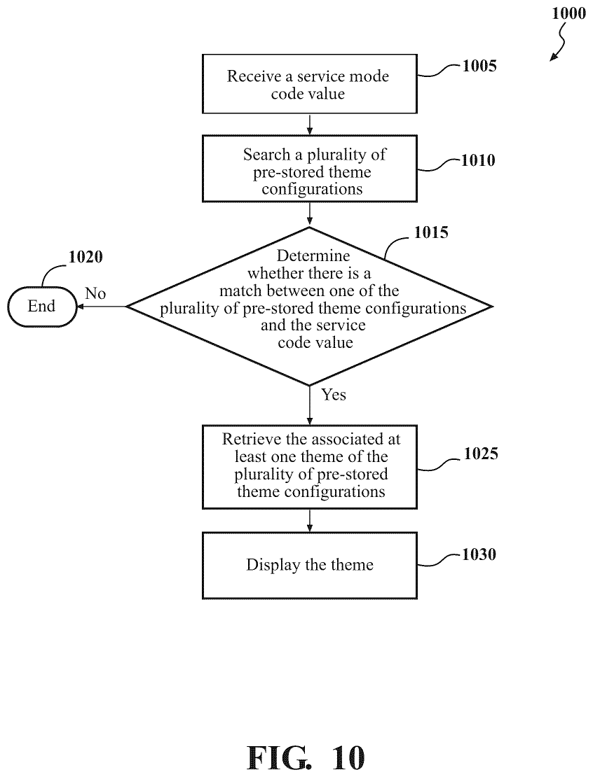

Referring now to FIG. 10, which depicts a flow diagram that graphically depicts an illustrative method 1000 for displaying a customized graphical element display information on the in-hall display device without the need for further software or application programming is provided. Although the steps associated with the blocks of FIG. 10 will be described as being separate tasks, in other embodiments, the blocks may be combined or omitted. Further, while the steps associated with the blocks of FIG. 10 will described as being performed in a particular order, in other embodiments, the steps may be performed in a different order and may be continuously performed or performed at discrete intervals. Lastly, the steps associated with the blocks of FIG.

10 may be performed independently from, in combination with, or simultaneously with the steps associated with the blocks of FIGS. 5-7.

At block 1005, the in-hall display device receives a service mode code value from the elevator controller. The service mode code value is a request from the elevator controller to the in-hall display device to display a graphical element display information that is currently desirable based on the operating conditions of the elevator system. At block 1010, upon receiving the service mode code value, one or more processors of the in-hall display device search a data storage repository that stores a plurality of pre-stored graphical element display information data, each includes an identifier.

Each identifier for each of the plurality of pre-stored graphical element display information data may be associated with the service mode code value. As such, it should be understood that instead of, or rather than, the elevator controller sending the actual customized graphical element display information data, which is a large amount of data requiring large bandwidth and additional software application programming, significant less data is actually transmitted that is associated with, or correlated to the current service mode of the elevator system and the in-hall display device itself searches the data storage repository to then obtain the data for the desired graphical element display information data associated with the service mode of the elevator system for display by the in-hall display device. That is, the identifier for each of the plurality of pre-stored graphical element display information data are associated with the service mode code value generated by the elevator controller. As such, based on real-time operating conditions, the in-hall display device may display, in real time, different or customized graphical element display information data (e.g., numbers, letters, words, objects, images, pages, combinations thereof, and/or the like).

At block 1015, the one or more processors of the in-hall display device determine whether there is a match between the request and one of the plurality of pre-stored graphical element display information data. For example, the match could be with identifier (e.g., the in-cab numerical value associated with each one of the plurality of pre-stored graphical element display information data) and the service mode code value. This is non-limiting and other matches or determinations may be made between the identifier of each one of the plurality of pre-stored theme configurations, and the service mode code value. If there is not a match, then the method 1000 ends, at block 1020. If a match is determined at block 1015, then the associated at least one graphical element display information data of the plurality of pre-stored graphical element display information data is retrieved by the in-hall display device, at block 1025, and the at least one graphical element display information data of the plurality of pre-stored graphical element display information data is displayed, at block 1030, by the notification device of the in-hall display device. As such, the elevator controller may request the desired graphical element display information to be displayed by providing a service mode code value to the in-hall display device.

It should now be understood that the embodiments described herein are directed to improved systems and methods for displaying customized graphical element information (e.g., numbers, letters, words, objects, images, pages, combinations thereof, and/or the like) on an in-elevator cab-operating panel (COP) display device without a need for a software change in the COP display device. Further, the embodiments described herein are directed to improved systems and methods for computer functionality by permitting limited data to be transmitted between the elevator controller, the design-computing module, and the in-elevator COP display device thereby reducing the amount of memory required, reduction in a data storage required, and a reduction in an amount of transmitted data that is required to be stored on the elevator controller and/or the design-computing module, and transmitted between the elevator controller, the design-computing module, and/or the COP display device. Further, the embodiments described herein improve computer graphic user interfaces by permitting for customized graphical element information data to be displayed of the COP display device without the requirement of additional software changes to the COP display device.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A display device of an elevator system comprising one or more processors configured to:
receive a service mode code value as a request to display a graphical element display information, the service mode code value transmitted from an elevator controller;
search a data storage repository for an identifier that is associated with at least one of a plurality of pre-stored graphical element display information data, the identifier is associated with the service mode code value;
determine whether there is a match between the identifier for at least one of the plurality of pre-stored graphical element display information data and the service mode code value for the graphical element display information to be displayed; and
upon determination of the match, display the one of the plurality of pre-stored graphical element display information data associated with the service mode code value by the display device.

2. The display device of claim 1, wherein the display device is an in-elevator cab display device positioned within an elevator cab of the elevator system such that passengers within the elevator cab have visual access to the graphical element display information that is displayed on the display.

3. The display device of claim 1, wherein the display device is an in-hall display device positioned within a lobby or a landing area such that passengers outside of an elevator cab have visual access to the graphical element display information that is displayed on the display.

4. The display device of claim 1, wherein the service mode code value is generated by the elevator controller to correlate to a current operating condition of the elevator system.

5. The display device of claim 1, wherein the display device includes the data storage repository configured to be searched by the one or more processors to retrieve at least one of the plurality of pre-stored graphical element display information data having the identifier that matches the service mode code value.

6. The display device of claim 5, wherein the plurality of pre-stored graphical element display information data are created in advance and transmitted to the display device for storage and searching.

7. The display device of claim 1, wherein the one or more processors are configured to search a web-based data repository for the plurality of pre-stored graphical element display information data.

8. A method for displaying data on a display device of an elevator system, the method comprising:
creating at least one graphical element display information data using a first computing processing unit;
associating each of the at least one graphical element display information data with an identifier;
transmitting the at least one graphical element display information data with the corresponding identifier to the display device;
receiving, by the display device, a service mode code value as a request to display a graphical element display information;
in response, the display device searching a data storage repository for the identifier that is associated with at least one of a plurality of pre-stored graphical element display information data based on the service mode code value;
determining whether there is a match between the identifier of one of the plurality of pre-stored graphical element display information data and the service mode code value; and
upon determination of the match, displaying the at least one of the plurality of pre-stored graphical element display information data associated with the service mode code value by the display device.

9. The method of claim 8, wherein a design-computing module or a user-computing device generates and transmits each of the plurality of pre-stored graphical element display information data with the identifier to the display device.

10. The method of claim 9, wherein the design-computing module or the user-computing device are remote from the display device.

11. The method of claim 8, wherein the service mode code value is transmitted to the display device via an elevator controller.

12. The method of claim 8, wherein the display device is an in-elevator cab display device positioned within an elevator cab of the elevator system such that passengers within the elevator cab have visual access to the graphical element display information that is displayed on the display.

13. The method of claim 8, wherein the display device is an in-hall display device positioned within a lobby or a landing area such that passengers exterior to an elevator cab may have visual access to the graphical element display information that is displayed on the display.

14. The method of claim 8, wherein the display device includes the data storage repository.

15. An elevator system comprising:
a computing processing unit configured to generate and transmit a plurality of pre-stored graphical element display information data, each one of the plurality of pre-stored graphical element display information data having an identifier; and
an elevator assembly comprising:
an elevator cab;
an elevator controller configured to control operation of the elevator cab and configured to transmit a service mode code value indicative of a current operating condition of the elevator system, the transmitted service mode code value is a request to display a graphical element display information; and
a display device comprising one or more processors configured to:
receive the plurality of pre-stored graphical element display information data;
receive the service mode code value indicative of the request to display the graphical element display information;
in response to receiving the service mode code value, search a data storage repository for the identifier that is associated with at least one of the plurality of pre-stored graphical element display information data based on the service mode code value;
determine whether there is a match between the identifier for at least one of the plurality of pre-stored graphical element display information data and the service mode code value; and
upon determination of the match, display the at least one of the plurality of pre-stored graphical element display information data associated with the service mode code value by the display device.

16. The elevator system of claim 15, wherein the computing processing unit is remote from the elevator assembly.

17. The elevator system of claim 15, wherein the display device is an in-elevator cab display device positioned within the elevator cab of the elevator system such that passengers within the elevator cab have visual access to the graphical element display information that is displayed on the display.

18. The elevator system of claim 15, wherein the display device is an in-hall display device positioned within a lobby or a landing area such that passengers outside of the elevator cab may have visual access to the graphical element display information that is displayed on the display.

19. The elevator system of claim 15, wherein the display device includes the data storage repository that stores the plurality of pre-stored graphical element display information data.

20. The elevator system of claim 15, wherein the one or more processors are configured to search a web-based data repository for the plurality of pre-stored graphical element display information data.
